(19) United States
(12) Patent Application Publication
(10) Pub. No.: US 2025/0319426 A1
(43) Pub. Date: Oct. 16, 2025

(54) Filtration System

(71) Applicant: Andrew Hansen, Provo, UT (US)

(72) Inventor: Andrew Hansen, Provo, UT (US)

(21) Appl. No.: 19/094,784

(22) Filed: Mar. 28, 2025

Related U.S. Application Data
(60) Provisional application No. 63/632,796, filed on Apr. 11, 2024.

(51) Int. Cl. B01D 24/14; B01D 24/40

(52) U.S. Cl. CPC B01D 24/14; B01D 24/402; B01D 2201/167; B01D 2201/347; B01D 2201/4092

(57) ABSTRACT

A water filter includes an elongated housing including a first distal portion forming a mouth, a second distal portion forming holes, and a sidewall forming a nozzle that is fluidly coupled to an inner chamber of the elongated housing via a passage. The inner chamber fluidly couples the mouth with: the nozzle in a first configuration; and an external environment via the holes in a second configuration. The water filter includes a substantially spherical structure disposed in the inner chamber. The substantially spherical structure is configured to be forced: toward the mouth in the first configuration; and toward a portion of the inner chamber that is opposite the mouth in the second configuration to create a temporary seal. The elongated housing forms a protrusion that extends into the inner chamber and is configured to prevent the substantially spherical structure from exiting through the mouth.

### PRIORITY CLAIM

This application claims priority to U.S. Provisional Application No. 63/632,796, titled “Filtration System,” filed on Apr. 11, 2024, and which is incorporated by reference in its entirety.

### COPYRIGHT NOTICE

A portion of the disclosure of this patent document contains material which is subject to copyright protection. The owner, Andrew Hansen, has no objection to the facsimile reproduction by anyone of the patent document or the patent disclosure, as it appears in the Patent and Trademark Office patent file or records, but otherwise reserves all copyright rights whatsoever.

### BACKGROUND

Filtration systems are used for filtering water in myriad settings, such as outdoor bodies of water.

### BRIEF DESCRIPTION OF THE DRAWINGS

In order to describe the manner in which the above-recited and other advantages and features of the present disclosure can be obtained, a more particular description of the present disclosure briefly described above will be rendered by reference to specific embodiments thereof which are illustrated in the appended drawings. Understanding that these drawings depict only typical embodiments of the present disclosure and are not therefore to be considered limiting of its scope, the disclosure will be described and explained with additional specificity and detail through the use of the accompanying drawings in which:

FIG. 1 illustrates an exploded perspective view of a filtration system, according to certain embodiments.

FIG. 2 illustrates an exploded side view of a filtration system, according to certain embodiments.

FIG. 3 illustrates a top view of a filtration system, according to certain embodiments.

FIG. 4 illustrates a perspective view of a filter of a filtration system, according to certain embodiments.

FIGS. 5A and B illustrate top, cross-sectional views of filters of filtration systems, according to certain embodiments.

FIGS. 6A and B illustrate side, cross-sectional views of filters of filtration systems, according to certain embodiments.

FIG. 7 illustrates a perspective view of a basket of a filtration system, according to certain embodiments.

FIG. 8 illustrates a side view of a basket of a filtration system, according to certain embodiments.

FIG. 9 illustrates a top view of a basket of a filtration system, according to certain embodiments.

FIG. 10 illustrates a perspective view of a filter of a filtration system, according to certain embodiment.

FIGS. 11A and B illustrate side, cross-sectional views of filters of filtration systems according to certain embodiments.

### DETAILED DESCRIPTION

The present disclosure relates to a filtration system for filtering outdoor bodies of water. In some embodiments, the present disclosure relates to an improvement in the mechanism that backwashes or moves the filtration media.

Filtration systems are frequently used to filter water in bodies of water, both indoor and outdoor. Filtration systems may be used by homeowners who have indoor water features or outdoor bodies of water on their property. Other users could include commercial establishments such as hotels, resorts, golf courses, or public parks that use bodies of water as functional features or in aesthetic landscape architecture. Additionally, municipalities or government agencies may utilize filtration systems for cleaning water on public lands, or even for aquaculture where ponds are used to raise fish or other aquatic organisms for food or recreation.

Filtration systems are used in myriad settings by many different users, each of differing expertise. Regardless of these differences in setting or user, filtration systems are used to attempt to maintain water quality and promote a healthy aquatic environment by removing biological contaminates and particles or other debris from a body of water.

In general, filtration systems include one or more containers with filter media enclosed therein, various filtering mechanisms, systems of valves and pipes, and a pump. When operating, the pump draws water from the body of water, for example a pond, into the filtration system, where the unfiltered water flows unidirectionally through a series of pipes and filtering mechanisms. After filtration, the water exits the filtration system and returns to the body of water from which it came. In sum, the pump serves to circulate water from the body of water, through the filtration system, and back into the body of water.

Varying water filtration systems use a large basin where a filtering media is placed to remove biological contaminates and particles from a body of water. A pump is used to create a flow to push the fluid through the system. During filtering operation, fluid passes through a valve system comprising horizontal filters and the pressure of the fluid forces it back out into the body of water with contaminate removed. During the filtration process (especially when filtering bio-heavy liquid) there is a significant build up around the horizontal filters that encumbers or stops the effectives of the filtration process. Therefore, it is necessary for users of the filtration systems to perform a backwash which is a method of pushing the fluid to flow in a direction opposite to a first flow direction to clear debris and shift the media around to make the filtration more effective again.

In some current systems, backwashing pushes the fluid directly back into and through the horizontal filters. The resulting turbulence and pressure with fluid and media that is heavily contaminated is insufficient to maintain normal operation with the filtration system. Accordingly, a filtration system that more effectively reduces build up is desired.

Mechanical filtration of the water involves physically trapping debris and particles suspended in the unfiltered water. This may occur through use of a filter medium such as foam pads, filter brushes, or filter mats. The filter medium can have varying sizes of pores or various densities of material through which water flows, allowing control of the size of particles filtered out, from smaller objects such as fish waste and uneaten fish food, to larger debris such as leaves, twigs, etc.

Chemical filtration can also be utilized to further purify the water by using specialized filter media designed to adsorb chemicals, odors, or excess nutrients like phosphates. In some systems, ultra-violet (UV) sterilization is utilized to control algae blooms and pathogens in the water. The UV light kills various cells and pathogens, helping to maintain water clarity and favorable aquatic conditions for wildlife.

During use of the filtration system (especially when filtering bio-heavy liquid), conventionally there is a significant build up around the filters that may encumber or even stop the flow of water, thereby decreasing the effectives of the filtration process or prohibiting filtration altogether.

To alleviate this problem of buildup, users of the filtration systems routinely perform a backwash of the system, which is a method of reversing the flow of fluid in an opposite direction to dislodge and clear debris in the filtering mechanism.

Conventionally, several problems may arise during this backwash process. In some conventional systems, backwashing pushes the fluid directly back into and through horizontal filters of the filtration system. The resulting turbulence due to the backflow of the fluid can create pressure which can damage components of the filtration system or even cause leaks. In some conventional systems, backwashing with increased turbulence does not effectively remove all debris from the filter media. This results in restriction of water flow and accumulation of compaction of debris on the filter media over time, thereby shortening the life of the filtration system or filters.

Consequently, there remain long-felt and unmet needs for current filtration systems to overcome these and other problems. The present disclosure more effectively reduces build up and solves problems associated with the backwashing process. The systems, devices, and methods of use of the present disclosure solve these and other limitations and shortcomings of present filtration systems.

A water filter of the present disclosure includes an elongated housing comprising a first distal portion forming a mouth and threaded portion configured to fluidly couple the water filter to a fluid source, and a second distal portion forming a plurality of holes configured to fluidly couple the interior of the water filter and an external environment. The elongated housing forms an inner chamber disposed between the first distal portion and the second distal portion, where the inner chamber fluidly couples the mouth with the second distal portion in a first configuration. The inner chamber structure fluidly couples the mouth with the external environment in a second configuration.

A water filter also includes a substantially spherical structure disposed in the inner chamber, the substantially spherical structure being configured to be forced by fluid toward the mouth in the first configuration. The elongated housing forms a protrusion that extends into the inner chamber and is configured to prevent the substantially spherical structure from exiting through the mouth in the first configuration. The substantially spherical structure is configured to be forced toward a portion of the inner chamber that is opposite the mouth in the second configuration to create a temporary seal.

A water filter further includes a nozzle configured to extend through a wall of the elongated housing, wherein the nozzle is configured to be fluidly coupled to the inner chamber structure via a passage.

A water filtration system of the present disclosure includes a filtration container configured to store filter media. The filtration container including a base end and a top end opposite the base end. The water filtration system also includes a valve body including a handle, a water flow controller, a plurality of inlet paths, a plurality of outlet paths, and a basket. The filtration container also includes a central pipe fluidly coupling the valve body with the filtration container and filters fluidly coupled to the central pipe, the filters positioned around the central pipe.

The present disclosure improves current filtration systems by providing horizontal filters having circular holes, which are of a size which allow a large amount of fluid to flow through while being just small enough to prevent typical bio-media such as leaves, twigs, and other organic matter from passing through. This increases the flow rate compared to conventional systems, and therefore larger volumes of water are capable of being filtered by the present disclosure in a shorter amount of time.

In some embodiments, each horizontal filter of the present disclosure includes a one-way check-valve which either directs the fluid through the filtration holes or through the nozzle. During “backwash” mode where the fluid is made to change direction, the fluid is forced through nozzles in each horizontal filter. These nozzles decrease the cross-sectional area through which the fluid passes and, in turn, converts pressure into velocity. The increased velocity of the fluid is used to create turbulence in the media which serves the dual purpose of clearing the horizontal filters and mixing the bio-media.

The present disclosure may include a basket or “cap” to be used in existing filtration systems. The basket forms holes substantially equivalent in size as the holes in the horizontal filters of the present disclosure.

The filtration system of the present disclosure increases the life of the filters and the filtration system compared to conventional systems. The filtration system of the present disclosure also more effectively backwashes the filter media compared to conventional system.

Although some embodiments of the present disclosure are described with relation to water (e.g., water filter, water filtration system, etc.), the present disclosure can be used to filter other types of fluids (e.g., liquids, gases, mixtures, etc.).

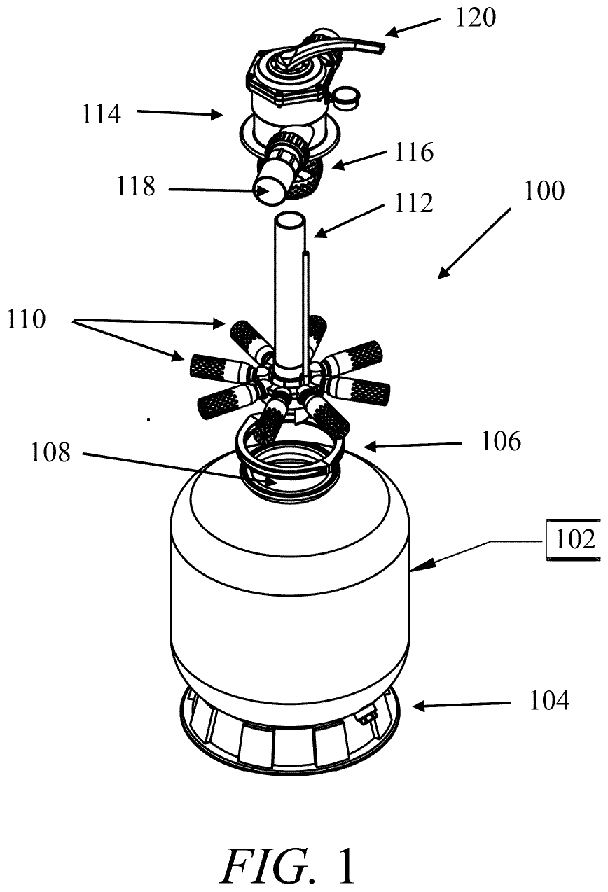

FIG. 1 is an exploded perspective view of a filtration system 100, according to certain embodiments. In some embodiments, the filtration system 100 includes a filtration container 102 configured to store filter media therein. The filter media may include chemicals, granules, packets, etc. The filter media may be used to purify water by chemical adsorption, by removing odors, or by removing excess nutrients like phosphates. The filter media may additionally include bacteria that is used to break down biologic material in fluid (e.g., pond water). The filtration container 102 further includes a base end 104 and a top end 106 opposite the base end. A circular opening 108 into the container 102 may be located at the top end 106. The circular opening 108 may further include a threaded portion for attaching to other components (e.g., fluid source, external source, etc.) of the filtration system 100. The circular opening 108 may further include other fastening features to attach other components of the filtration system 100.

Horizontal filters 110 may be fluidly coupled to a central pipe 112. The central pipe 112 may be disposed along a central axis. The horizontal filters 110 may be positioned around the central axis. In some embodiments, eight horizontal filters are fluidly coupled to the central pipe 112. The central pipe 112 can be fluidly coupled to an inlet path 118 formed by valve body 114 such that water is drawn into the filtration system 100 from the body of water via the inlet path 118. The valve body 114 can include a handle 120, a water flow controller, inlet path 118, and basket 116. The basket 116 may be used to convert filtration systems to include one or more components of the present disclosure.

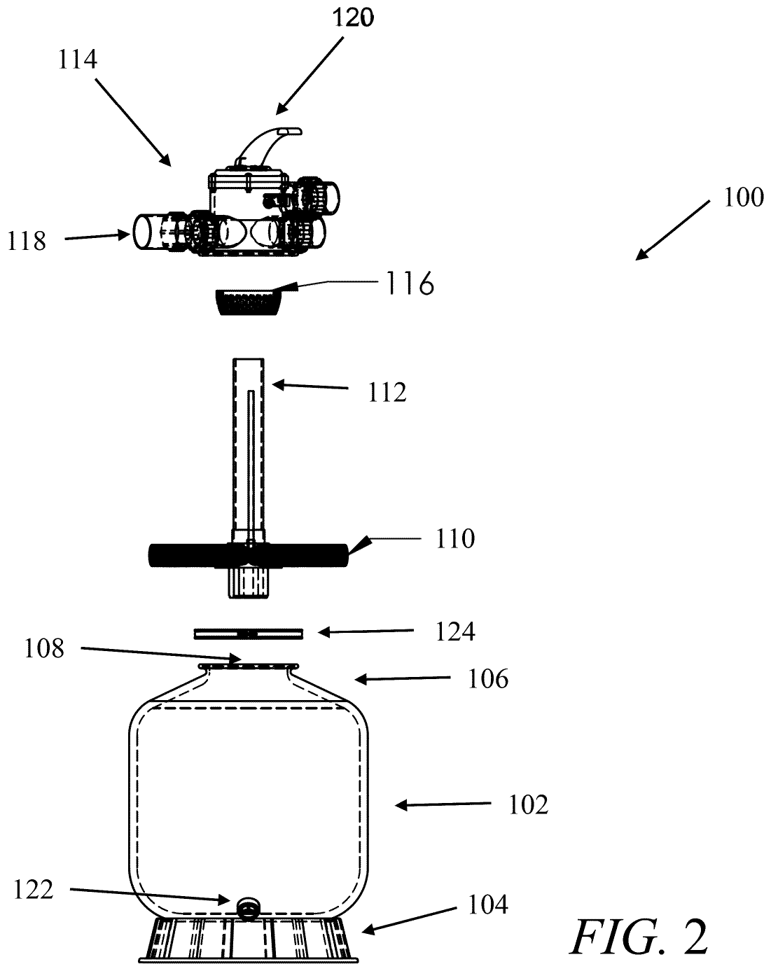

FIG. 2 illustrates an exploded side view of a filtration system 100, of similar nature to the embodiment described in FIG. 1. The container 102 may further form a drain hole 122 that is proximate the base end 104. In some embodiments, the drain hole 122 is a hole which fluidly couples the inside of the container 102 to the external environment. The drain hole 122 may include threads or other fastening structure configured to fluidly couple the drain hole 122 to external pipes, hoses, valves, and/or the like. In some embodiments, the drain hole 122 can be fully stopped with a drain plug or other stopping structure such as a cap. The drain hole 122 can also be in a fully open position, allowing filter media or other fluid to flow freely out of the container 102 via the drain hole 122. The valve body 114 can further form one or more inlet paths and/or one or more outlet paths (e.g., formed by valves) in addition to the inlet path 118. A gasket 124 may be disposed between the circular opening 108 and other components of the filtration system 100 to inhibit or prevent water flow out of the filtration system 100. The gasket 124 may be a rubber gasket and may be shaped as a toroid such a seal is created between components of the filtration system 100 while still allowing fluid flow through the gasket 124.

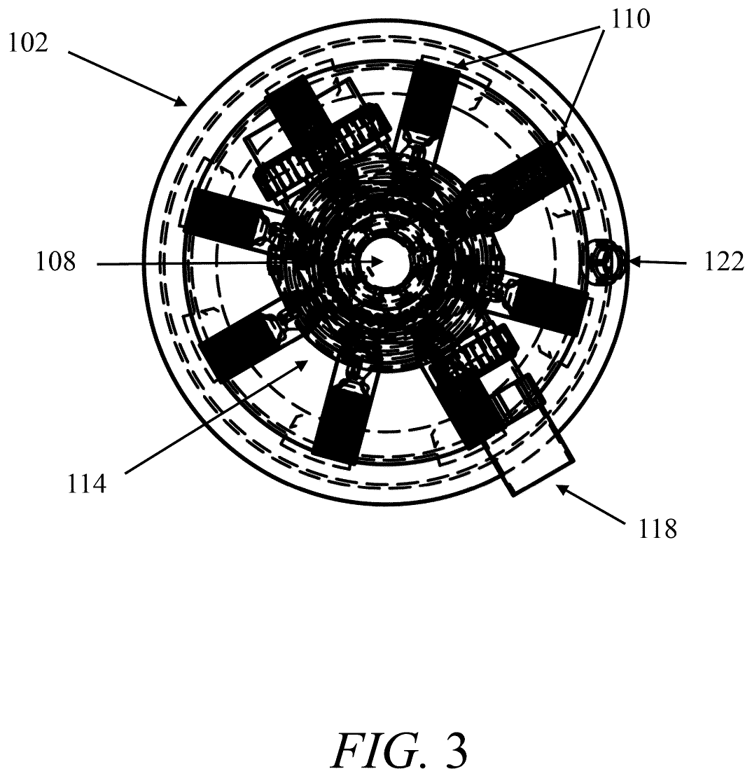

FIG. 3 illustrates a top view of a filtration system 100. The filtration system 100 of FIG. 3 may have one or more of substantially the same or similar functionality, materials, structure, and/or components as the filtration system 100 of FIG. 1 and/o FIG. 2. In some embodiments, the horizontal filters 110 are disposed within the filtration container 102 responsive to the filtration system 100 being in an assembled configuration. The horizontal filters 110 may be submerged in filter media within the filtration container 102 in an assembled configuration.

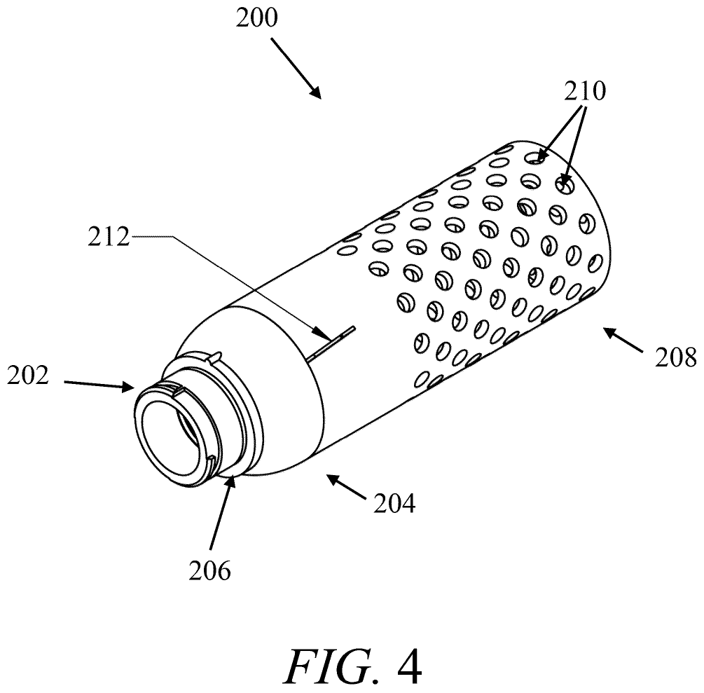

FIG. 4 illustrates a perspective view of a filter 200 (e.g., horizontal filter 110 of one or more of FIGS. 1-3), according to certain embodiments. A connecting end 202 including a mouth into the filter 200 can be located at a proximal end 204 of a filter 200. The connecting end 202 can include threads for fluidly coupling the filter 200 to a filtration system 100. The filter 200 can be inserted or coupled into a filtration system 100 by positioning the filter 200 in an up-right position, aligning physical indicators, and then turning the filter 200 to the right, for example, thereby securing the female threads with corresponding male threads to create a secure fluid connection between the filter 200 and the filtration system 100.

The filter 200 can further form a divot 206 (e.g., recess) configured to receive an o-ring or gasket, thereby creating a tighter seal and hindering or preventing fluid from leaking or moving in an undesirable path. The o-ring or gasket can be made of a synthetic rubber material such as ethylene propylene diene monomer, fluoroelastomer, nitrile, silicone, etc. The filter 200 can have a distal end 208, opposite the proximal end 204. Starting between the proximal end 204 and continuing to the distal end 208, the filter 200 may form holes 210 in the housing of the filter 200. The holes 210 can extend through the housing of the filter 200, exposing the interior of the filter 200 to the exterior environment. In an assembled configuration, the holes 210 can fluidly connect the interior of the filter 200 to the interior of the container 102 that stores the filter media. The plurality of holes 210 may have a hole diameter shaped to allow a large amount of fluid to pass therethrough without allowing media used in various fluid filtration systems from passing therethrough. A nozzle 212 can be positioned as shown in FIG. 4 whereby in certain configurations, fluid is evacuated out of the filter 200 via the nozzle 212. The role of the nozzle 212 will be further explained below.

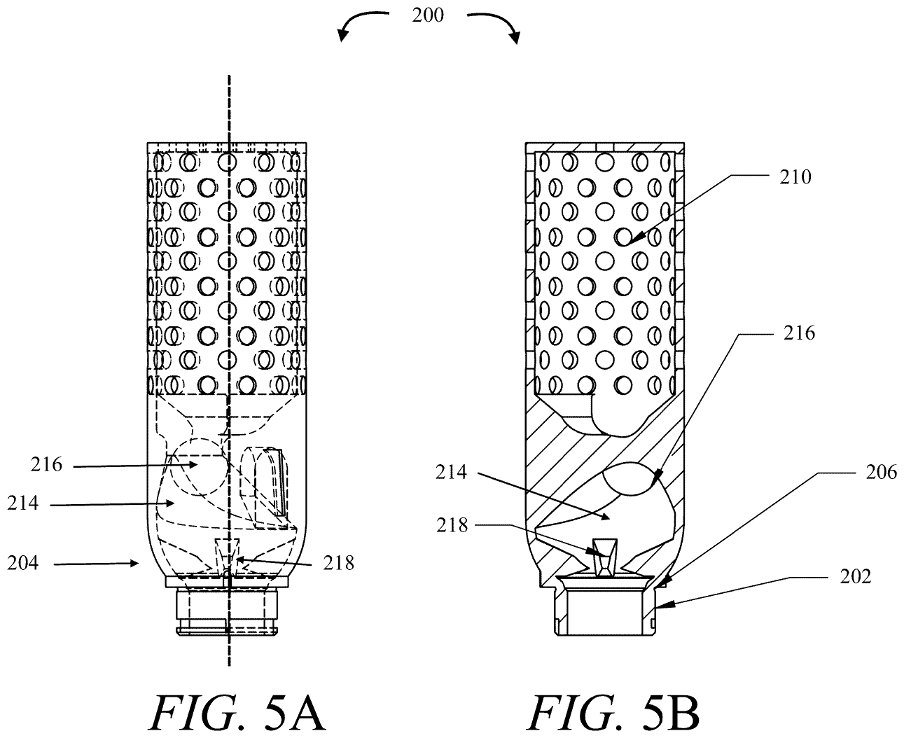

FIGS. 5A and B illustrate top, cross-sectional views of filters 200, according to certain embodiments. In some embodiments, FIG. 5B is a mirror image of FIG. 5A, reflected about an imaginary axis between the two figures. In the cross-sectional view, it can be seen that the filter 200 (e.g., elongated housing of filter 200) may form an inner chamber 214. A ball 216 or other substantially spherical structure can be positioned within the inner chamber 214 such that the ball 216 is enclosed within the inner chamber 214 and cannot escape. The ball 216 can be made of a nylon material. Further, a physical protrusion 218 of the housing of the filter 200 can extend partially into the inner chamber 214. The physical protrusion 218 can be located near the proximal end 204. A filter 200, in some embodiments, is configured to be fluidly coupled to filtration systems common in the art, such that the filter 200 may be retrofitted onto prior art devices.

During normal filtration, pressure created by a pump creates a flow of water through the filtration system 100 pushing the ball 216 toward the proximal end 204 of the inner chamber 214. In this configuration, the ball 216 and the inner chamber 214 function as a check valve. During normal filtration, the physical protrusion 218 prevents the ball 216 from passing through the proximal end 204 of the inner chamber 214 and back into the filtration system 100 while still allowing fluid to flow around the ball 216.

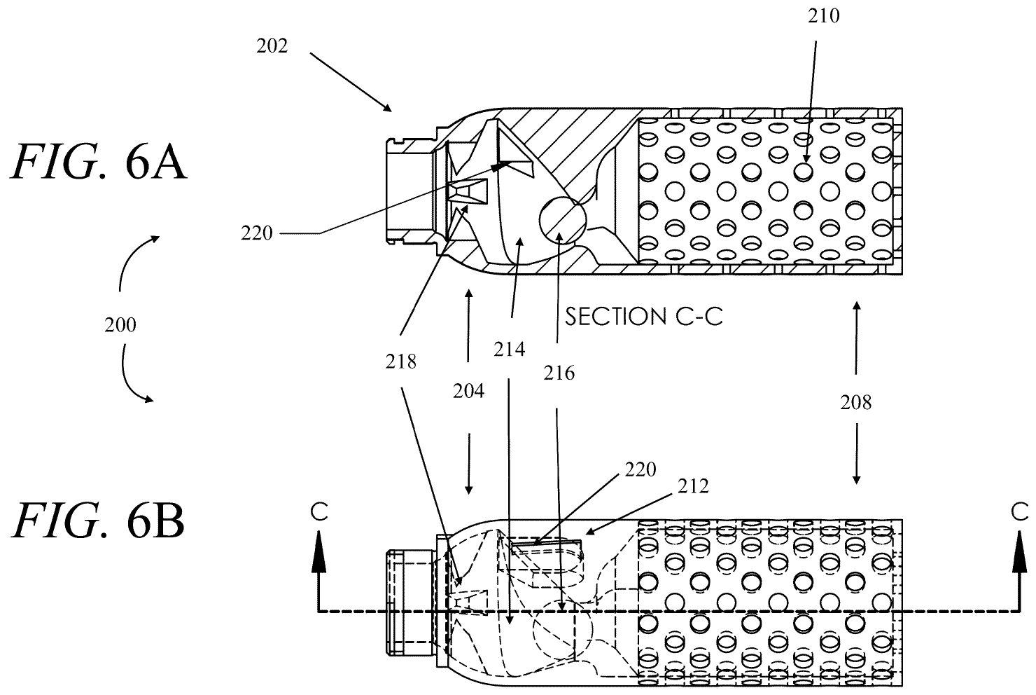

A passage 220 fluidly couples the inner chamber 214 to the exterior environment via the nozzle 212 as shown in FIGS. 6A and B which both illustrate a side, cross-sectional view of a filter 200, according to certain embodiments. In other words, the inner chamber 214 can be fluidly coupled to a passage 220 which terminates at the nozzle 212 where fluid may exit the filter 200 into the exterior environment. As described above, in an assembled configuration, the plurality of horizontal filters 110 may be disposed within the container 102 of the filtration system 100. In this configuration, the horizontal filters 110 may be at least partially submerged in a filter media.

During a “backwash,” in which the direction of the fluid is reversed as described above, the ball 216 is pushed toward the distal end 208 of the filter 200 as depicted in FIGS. 6A and B. The ball 216 remains within the inner chamber 214 but is lodged at a distal end of the inner chamber 214, thereby creating a temporary seal which stops or reduces the flow of fluid into the distal end 208 of the filter and out the plurality of holes 210. In this configuration during a backwash, fluid is instead forced from the inner chamber 214 and into passage 220, thereafter exiting the filter 200 via the nozzle 212. The space surrounding these elements of the filter 200 is large enough to prevent the system from getting stuck when biological particulates inevitably pass through.

In an assembled configuration, the horizontal filters 110 are at least partially submerged in the filter media and fluid may exit out of the filter 200 via nozzle 212 into the filter media, causing the filter media to experience increased turbulence. The nozzles 212 serve to decrease the cross-sectional area through which the pressurized fluid passes which results in increased velocity of the exiting fluid. The high velocity of the exiting fluid results in increased turbulence in the filter media within the filtration container 102. This increased turbulence in the filter media may break up and dislodge any accumulation or build up around the plurality of horizontal filters 110, thereby cleaning the horizontal filters. An increased turbulence in the filter media may also mix any bio-media or chemical compound found in the filtration container 102, thereby increasing the effectiveness of the bio-media or chemical.

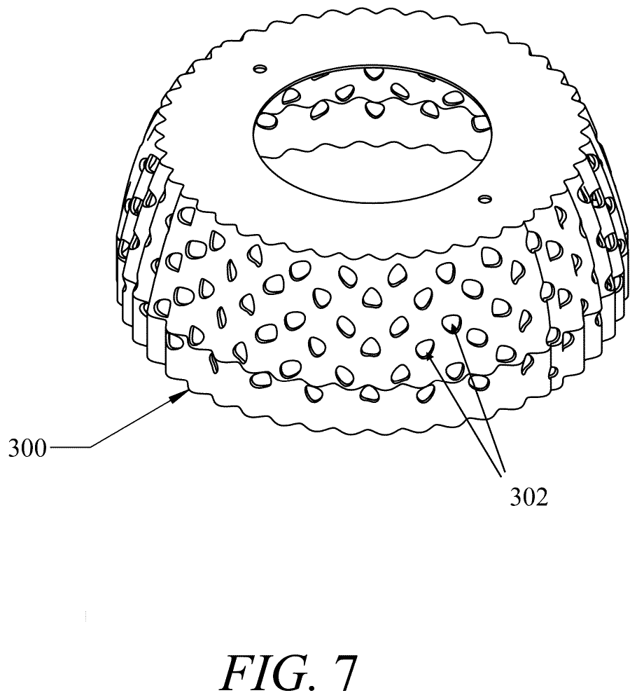

FIG. 7 illustrates an perspective view of a basket 300, according to certain embodiments. The basket 300, also termed cap, may have a substantially circular perimeter with a hole extending centrally therethrough. The basket 300 may also include a top surface which is substantially planar, a hole extending centrally therethrough. The basket 300 may further form holes 302, that may be substantially identical in diameter to the holes 210 in the housing of the filter 200. Additionally, the diameter of the holes 302 may be larger or smaller than the holes 210 in the elongated housing of the filter 200. The basket 300 may prevent media from escaping the filtration system 100, e.g., back into a body of water. The basket 300 in some variations is fluidly coupled to the valve body 114 of filtration system 100 at the top end of a central pipe 112.

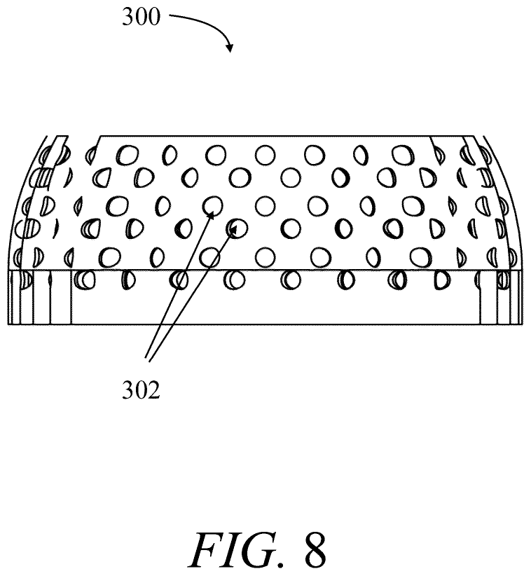

FIG. 8 illustrates a side view of a basket 300, according to certain embodiments. The basket 300 may be configured to be fluidly coupled to various filtration systems common in the art so as to retrofit the filtration system to be compatible with the present disclosure.

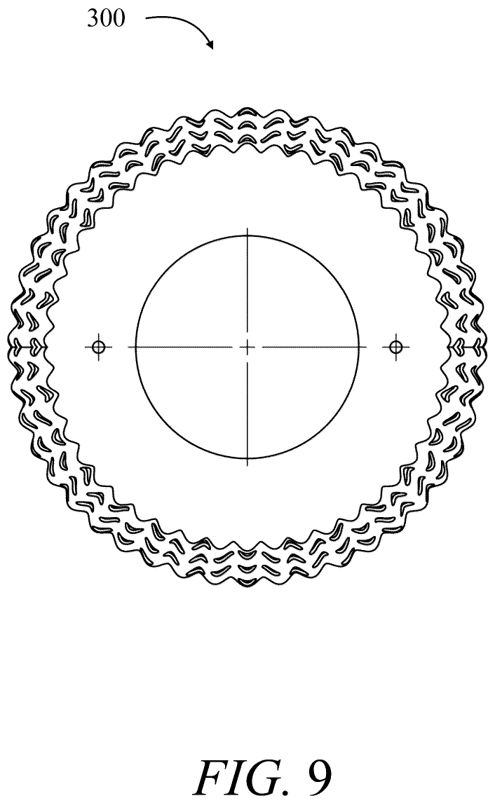

FIG. 9 illustrates a top view of a basket 300, according to certain embodiments.

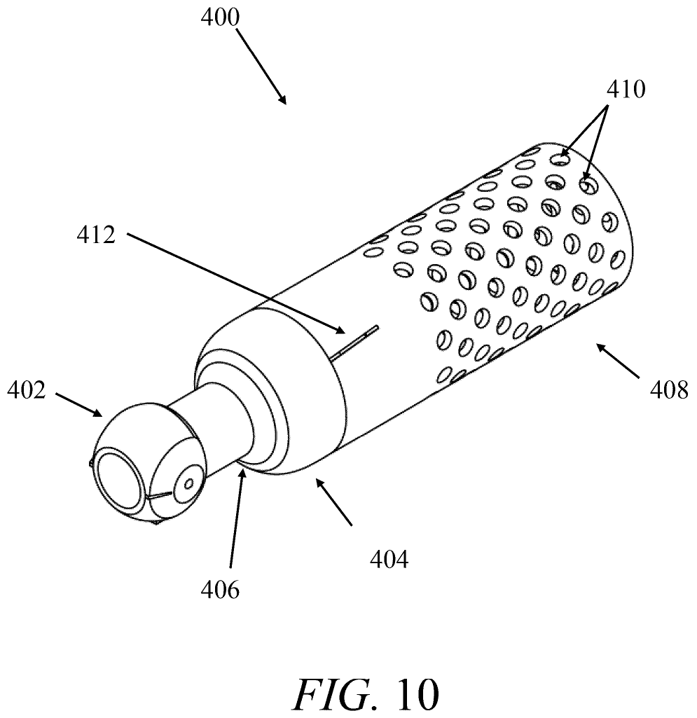

FIG. 10 illustrates a perspective view of a filter 400 (e.g., horizontal filter 110 of one or more of FIGS. 1-3), according to certain embodiments. A connecting end 402 including a mouth into the filter 400 can be located at a proximal end 404 of a filter 400. The connecting end 402 can include a ball-joint socket for fluidly coupling the filter 400 to a filtration system 100. The filter 400 can be inserted or coupled into a filtration system 100 by positioning the filter 400 in an up-right position, aligning physical indicators, and then attaching the filter 400, for example, thereby securing the ball-joint to the corresponding socket to create a secure fluid connection between the filter 400 and the filtration system 100.

The filter 400 can further form a divot 406 (e.g., recess) configured to receive an o-ring or gasket, thereby creating a tighter seal and hindering or preventing fluid from leaking or moving in an undesirable path. The o-ring or gasket can be made of a synthetic rubber material such as ethylene propylene diene monomer, fluoroelastomer, nitrile, silicone, etc. The filter 400 can have a distal end 408, opposite the proximal end 404. Starting between the proximal end 404 and continuing to the distal end 408, the filter 400 may form holes 410 in the housing of the filter 400. The holes 410 can extend through the housing of the filter 400, exposing the interior of the filter 400 to the exterior environment. In an assembled configuration, the holes 410 can fluidly connect the interior of the filter 400 to the interior of the container 102 of the filtration system 100 that stores the filter media. The plurality of holes 410 may have a hole diameter sized and shaped to allow a large amount of fluid to pass therethrough without allowing media used in various fluid filtration systems from passing therethrough. A nozzle 412 can be positioned as shown in FIG. 10 whereby in certain configurations, fluid is evacuated out of the filter 400 via the nozzle 412. The role of the nozzle 412 will be further explained below.

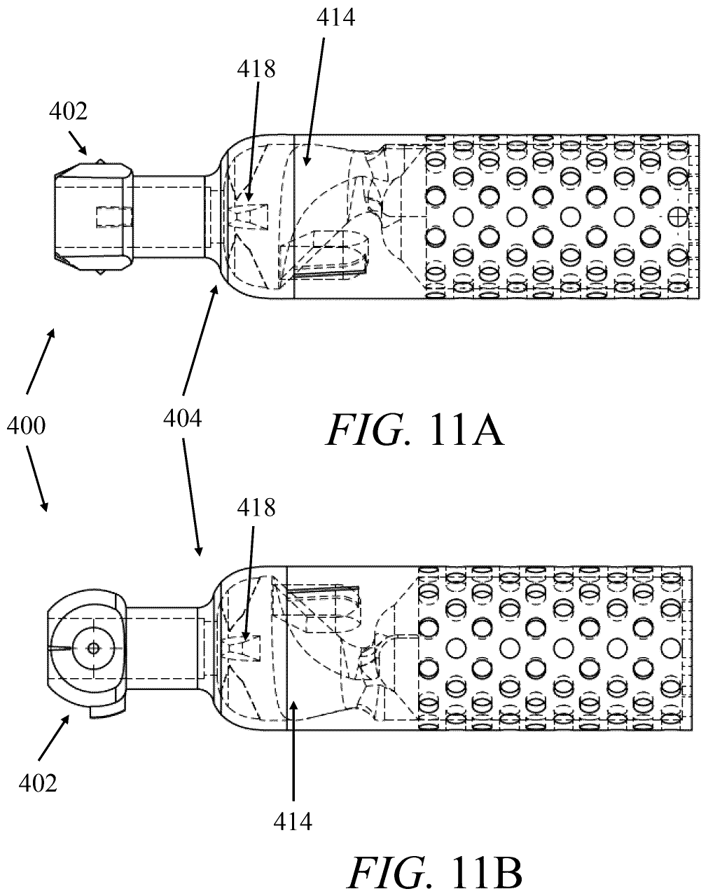

FIGS. 11A and B illustrate top, cross-sectional views of filters 400, according to certain embodiments. In some embodiments, FIG. 11B is a mirror image of FIG. 11A, reflected about an imaginary axis between the two figures. In the cross-sectional view, it can be seen that the filter 400 (e.g., elongated housing of filter 400) may form an inner chamber 414. A ball or other substantially spherical structure can be positioned within the inner chamber 214 such that the ball is enclosed within the inner chamber 414 and cannot escape. The ball can be made of a nylon material. Further, a physical protrusion 418 of the housing of the filter 400 can extend partially into the inner chamber 414. The physical protrusion 418 can be located near the proximal end 404. A filter 400, in some embodiments, is configured to be fluidly coupled to filtration systems common in the art, such that the filter 400 may be retrofitted onto prior art devices.

In some embodiments, during normal filtration, pressure created by a pump creates a flow of water through the filtration system 100 pushing the ball toward the proximal end 404 of the inner chamber 414. In this configuration, the ball 416 and the inner chamber 414 may function as a check valve. During normal filtration, the physical protrusion 418 may prevent the ball from passing through the proximal end 404 of the inner chamber 414 and back into the filtration system 100 while still allowing fluid to flow around the ball.

The foregoing embodiments provide a disclosure for a filtration system, filters, baskets, and methods of using the same.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

While the present disclosure has been described with respect to a limited number of embodiments, those skilled in the art will appreciate numerous modifications and variations therefrom. It is intended that the appended claims cover all such modifications and variations as fall within the true spirit and scope of this present disclosure and its inventive concepts.

The terminology used herein is for the purpose of describing particular embodiments only and is not intended to be limiting of the disclosure. It will be further understood that the terms “includes,” “including,” “comprises,” and/or “comprising” as used in this specification specify the presence of stated features, elements, components, steps, or operations, but do not preclude the presence of one or more other features, elements, components, or operations.

Unless otherwise defined, all terms (including technical and scientific terms) used in this specification have the same meaning as commonly understood by one having ordinary skill in the art. It will be further understood that terms should be interpreted as having a meaning that is consistent with their meaning in the context of the relevant art and the present disclosure and will not be interpreted in an idealized or overly formal sense unless expressly so defined in this specification.

Any of the features, embodiments, and functionalities of the present disclosure may be used in conjunction with each other. Similar features in different embodiments may have the same or similar structure, advantages, and/or functionalities as similar features in other embodiments.

Use of the phrase ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task.

Reference throughout this specification to “one embodiment,” “an embodiment,” “certain embodiments,” or “some embodiments” means that a particular feature, structure, or characteristic described in connection with the embodiment is included in at least one embodiment of the present disclosure. Thus, the appearances of the phrases “in one embodiment,” “in an embodiment,” “in certain embodiments,” “in other embodiments,” or “in some embodiments” in various places throughout this specification are not necessarily all referring to the same embodiment. Furthermore, the particular features, structures, or characteristics of any embodiments can be combined in any suitable manner with one or more embodiments.

The terms “over,” “under,” “between,” “disposed on,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers.

The words “example” or “exemplary” are used herein to mean serving as an example, instance or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Also, the terms “first,” “second,” “third,” “fourth,” etc. as used herein are meant as labels to distinguish among different elements and can not necessarily have an ordinal meaning according to their numerical designation. When the term “about,” “substantially,” or “approximately” is used herein, this is intended to mean that the nominal value presented is precise within +10%. Moreover, use of the term “an embodiment” or “one embodiment” or “an implementation” or “one implementation” throughout is not intended to mean the same embodiment or implementation unless described as such.

What is claimed is:

1. A water filter comprising:
an elongated housing comprising:
a first distal portion forming a mouth;
a second distal portion forming a plurality of holes, wherein the elongated housing forms an inner chamber that is disposed between the first distal portion and the second distal portion; and
a sidewall forming a nozzle, wherein the nozzle is fluidly coupled to the inner chamber via a passage, wherein the inner chamber fluidly couples the mouth with the nozzle in a first configuration, and wherein the inner chamber fluidly couples the mouth with an external environment via the plurality of holes in a second configuration; and
a substantially spherical structure disposed in the inner chamber, the substantially spherical structure being configured to be forced by fluid toward the mouth in the first configuration, wherein the elongated housing forms a protrusion that extends into the inner chamber and is configured to prevent the substantially spherical structure from exiting through the mouth in the first configuration, wherein the substantially spherical structure is configured to be forced toward a portion of the inner chamber that is opposite the mouth in the second configuration to create a temporary seal.

2. The water filter of claim 1, wherein the first distal portion forming the mouth further comprises a threaded portion configured to couple the water filter to a fluid source.

3. The water filter of claim 2, wherein at least one of an o-ring or a gasket is disposed on the threaded portion.

4. The water filter of claim 1, wherein the first distal portion forming the mouth further comprises a ball-joint socket portion configured to couple the water filter to a fluid source.

5. The water filter of claim 1, wherein the substantially spherical structure and the inner chamber are configured to operate as a check valve to prevent fluid from passing from the external environment into the fluid source.

6. The water filter of claim 1, wherein the fluid exits the elongated housing via the plurality of holes in the second configuration.

7. The water filter of claim 1, wherein the fluid exits the elongated housing via the nozzle in the first configuration.

8. The water filter of claim 1, wherein the elongated housing comprises a polymeric material.

9. A water filtration system comprising:
a filtration container configured to store filter media, the filtration container comprising a base end and a top end opposite the base end;
a valve body comprising a handle, a water flow controller, a plurality of inlet paths, a plurality of outlet paths, and a basket;
a central pipe fluidly coupling the valve body with the filtration container;
a plurality of filters fluidly coupled to the central pipe, the plurality of filters positioned around the central pipe.

10. The water filtration system of claim 9, wherein the plurality of filters comprises eight filters.

11. The water filtration system of claim 9, wherein the plurality of filters are at least partially submerged in filter media within the filtration container.

12. The water filtration system of claim 9, wherein the plurality of filters are connected to the central pipe via a threaded portion disposed on each of the filters.

13. The water filtration system of claim 9, wherein the plurality of filters are connected to the central pipe via a ball-joint socket portion disposed on each of the filters.

14. The water filtration system of claim 6, wherein the basket forms a plurality of holes extending therethrough.

15. A water filtration system comprising:
a filtration container configured to store filter media, the filtration container comprising a base end and a top end opposite the base end;
a valve body comprising a handle, a water flow controller, a plurality of inlet paths, a plurality of outlet paths, and a basket;
a central pipe fluidly coupling the valve body with the filtration container;
a plurality of filters, each filter comprising:
an elongated housing comprising:
a first distal portion forming a mouth;
a second distal portion forming a plurality of holes, wherein the elongated housing forms an inner chamber that is disposed between the first distal portion and the second distal portion; and
a sidewall forming a nozzle, wherein the nozzle is fluidly coupled to the inner chamber via a passage, wherein the inner chamber fluidly couples the mouth with the nozzle in a first configuration, and wherein the inner chamber fluidly couples the mouth with an external environment via the plurality of holes in a second configuration; and
a substantially spherical structure disposed in the inner chamber, the substantially spherical structure being configured to be forced by fluid toward the mouth in the first configuration, wherein the elongated housing forms a protrusion that extends into the inner chamber and is configured to prevent the substantially spherical structure from exiting through the mouth in the first configuration, wherein the substantially spherical structure is configured to be forced toward a portion of the inner chamber that is opposite the mouth in the second configuration to create a temporary seal,
fluidly coupled to the central pipe, the plurality of filters positioned around the central pipe.

16. The water filtration system of claim 15, wherein the plurality of filters comprises eight filters.

17. The water filtration system of claim 15, wherein the plurality of filters are at least partially submerged in filter media within the filtration container.

18. The water filtration system of claim 15, wherein the plurality of filters are connected to the central pipe via a threaded portion disposed on each of the filters.

19. The water filtration system of claim 9, the plurality of filters are connected to the central pipe via a ball-joint socket portion disposed on each of the filters.

20. The water filtration system of claim 6, wherein the basket forms a plurality of holes extending therethrough.
